(19) United States
(12) Patent Application Publication
(10) Pub. No.: US 2013/0188814 A1
(43) Pub. Date: Jul. 25, 2013

(54) HEARING AID WITH AN H-BRIDGE OUTPUT STAGE AND A METHOD OF DRIVING AN OUTPUT STAGE

(71) Applicant: Widex A/S, Lynge (DK)

(72) Inventors: Henning Haugaard ANDERSEN, Birkerod (DK); Niels Ole KNUDSEN, Humlebak (DK)

(73) Assignee: WIDEX A/S, Lynge (DK)

(21) Appl. No.: 13/845,721

(22) Filed: Mar. 18, 2013

Related U.S. Application Data
(63) Continuation-in-part of application No. PCT/EP2011/052887, filed on Feb. 28, 2011.

(51) Int. Cl. H04R 25/00; H04R 25/02

(52) U.S. Cl. CPC H04R 25/00
USPC 381/316

(57) ABSTRACT

A digital, three-level output driver (7) of the H-bridge variety for a hearing aid (20) obtains a reduced capacitive interference by providing a primary voltage (3) and a secondary voltage (8) for the output driver (7) and applying the secondary voltage (8) to both sides of the output driver (7) whenever the middle level of the three-level output driver (7) is present in the input signal for the output driver (7). The output driver (7) may be controlled from a pulse-width modulated signal, a sigma-delta pulse-density modulated signal, or a combination of those signals. The output driver (7) produces a clocked output signal consisting of a positive level, a negative level, and a zero level for driving an acoustic output transducer of the hearing aid (20). The invention provides a hearing aid (20) and a method of driving an output stage (7) of a hearing aid (20).

### RELATED APPLICATIONS

The present application is a continuation-in-part of application PCT/EP2011052887, filed on 28 Feb. 2011, in Europe, and published as WO 2012116720 A1.

### BACKGROUND OF THE INVENTION

1. Field of the Invention

This application relates to hearing aids. More specifically, it relates to hearing aids comprising digital output stages for driving acoustic output transducers. The invention further relates to a method for driving a digital output stage of a hearing aid.

In this context, a hearing aid is defined as a small, battery-powered device, comprising a microphone, an audio processor and an acoustic output transducer, configured to be worn in or behind the ear by a hearing-impaired person. By fitting the hearing aid according to a prescription calculated from a measurement of a hearing loss of the user, the hearing aid may amplify certain frequency bands in order to compensate the hearing loss in those frequency bands. In order to provide an accurate and flexible amplification, most modern hearing aids are of the digital variety.

Contemporary digital hearing aids incorporate a digital signal processor for processing audio signals from the microphone into electrical signals suitable for driving the acoustic output transducer according to the prescription. In order to save space and improve efficiency, some digital hearing aid processors use a digital output signal to drive the acoustic output transducer directly without performing a digital-to-analog conversion of the output signal. If the digital signal is delivered to the acoustic output transducer directly as a digital bit stream with a sufficiently high frequency, the coil of the acoustic output transducer performs the duty as a low-pass filter, allowing only frequencies below e.g. 15-20 kHz to be reproduced by the acoustic output transducer. The digital output signal is preferably a pulse width modulated signal, a sigma-delta modulated signal, or a combination thereof.

An H-bridge is an electronic circuit for controlling inductive loads such as electric motors or loudspeakers. It operates by controlling the direction of a flow of current through a load connected between the output terminals of the H-bridge by opening and closing a set of electronic switches present in the H-bridge. The switches may preferably be embodied as semiconductor switching elements such as BJT transistors or MOSFET transistors. This operating principle permits a direct digital drive output stage to be employed in order to enable a suitably conditioned digital signal to drive a loudspeaker directly, thus eliminating the need for a dedicated digital-to-analog converter and at the same time reducing the power requirements for the output stage.

A sigma-delta modulator is an electronic circuit for converting a signal into a bit stream. The signal to be converted may be digital or analog, and the sigma-delta modulator is typically used in applications where a signal of a high resolution is to be converted into a signal of a lower resolution. In this context, a sigma-delta modulator is used for driving the H-bridge output stage in the hearing aid.

The diaphragm of a loudspeaker has a resting or neutral position assumed whenever no current flows through the loudspeaker coil and two extreme positions assumed whenever the maximal allowable current flows in either direction through the loudspeaker. By applying a sufficiently fast-changing bit stream from an H-bridge represented by positive and negative voltage impulses to the loudspeaker terminals, any position between the two extreme diaphragm positions of the loudspeaker may be attained. The higher the number of positive impulses in the bit stream is, the more the loudspeaker diaphragm will move towards the first extreme position, and the higher the number of negative impulses in the bit stream is, the more the loudspeaker diaphragm will move towards the second extreme position. Due to the low-pass filtering effect of the loudspeaker coil, no audible switching noise will emanate from the loudspeaker when driven in this way, provided the switching period of the bit stream is well above the reproduction frequency limit of the loudspeaker. Thus, a digital bit stream may control a loudspeaker directly.

2. The Prior Art

From EP-B1-1716723 is known a digital output stage for a hearing aid, said output stage comprising a sigma-delta converter and an H-bridge for driving an acoustic output transducer for a hearing aid. The output stage is denoted a three-state output stage because it is capable of delivering a bit stream consisting of three individual signal levels to the acoustic output transducer. In the following, these levels are denoted “+1”, “−1” and “0”, where “+1” equals the maximum positive voltage across the acoustic output transducer, “−1” equals the maximum negative voltage across the acoustic output transducer, and “0” equals no voltage. This utilizes the fact that a positive voltage pulse makes the diaphragm of the acoustic output transducer move in one direction, and a negative voltage pulse makes the diaphragm of the acoustic output transducer move in the other direction. By delivering a clocked bit stream consisting of “+1”-levels and “−1”-levels interspersed with “0”-levels as voltage pulses to the acoustic output transducer, any position deviation within the confinements of the mechanical suspension of the acoustic output transducer diaphragm may thus be obtained, as the loudspeaker coil acts as an integrator of the voltage pulses. The digital output stage of the prior art generates the “0”-level by applying a “+1”-level and a “−1”-level simultaneously to both terminals of the acoustic output transducer.

This way of generating the “0”-level for the acoustic output transducer has the advantages of being very easy to implement, as no extra components are needed to provide the “0”-level, and to save power, as the “0”-level uses no extra current and the provision of three separate levels effectively doubles the possible voltage swing across the acoustic output transducer. However, it also has some inherent drawbacks, which will be explained in greater detail in the following.

The “+1”-levels and “−1”-levels both generate differential voltages over the wires and terminals of the acoustic output transducer. This is not the case with the “0”-level. With the “0”-level, both wires carry the same voltage simultaneously, and since this is a rapidly switching voltage it radiates more common mode signal to its immediate surroundings. This radiation results in increased crosstalk to nearby surroundings, such as telecoils or wireless transmission receiver coils typically present in the hearing aid. Since this crosstalk has frequencies above 1 MHz, it does not possess a problem to the telecoil, since a telecoil is configured to convey frequencies below 8-10 kHz. The wireless receiver coil, however, suffers a very considerable reduction in signal-to-noise ratio from the capacitive interference resulting from this crosstalk phenomenon, often to a degree where reliable signal reception becomes impossible.

This capacitive interference emanates mainly from electrically exposed parts of the output circuit, primarily the wires connecting the output pads of the electronic circuit chip of the hearing aid to the input terminals of the acoustic output transducer. It is not possible to shorten these wires further for mechanical reasons, but some reduction in the capacitive coupling between these wires and sensitive electronic circuits in the vicinity may be achieved by twisting the wires and keeping them physically close together.

The voltage pulses are presented to the output transducer at a frequency of 1-2 MHz, and the resulting noise components may thus disturb the operation of electronic circuits sensitive to capacitive interference at high frequencies. In cases where the afflicted electronic equipment incorporates a wireless remote control for the hearing aid the problems caused by electromagnetic interference are exceptionally severe, as the effective operating range of the wireless remote control is limited considerably by the capacitive interference emanating from the output stage and masking the remote control signals from proper reception.

WO-A1-03/047309 discloses a digital output driver circuit for driving a loudspeaker for a mobile device such as a hearing aid or a mobile phone. The digital driver circuit comprises an input, a modulator and a three-level H-bridge and is integrated into the loudspeaker enclosure in order to shield the driver circuit from electromagnetic interference and to keep the wires connecting the driver output to the loudspeaker short. The driver circuit further comprises a feedback circuit connected to the loudspeaker for regulating the supply voltage for the driver circuit.

An output driver integrated into a loudspeaker in the way described in WO-A1-03/047309 is not interchangeable with dynamic standard loudspeakers of the kind used in hearing aids. If, for example, a hearing aid housing and circuitry may be adapted for use with a range of different loudspeakers having different impedance values, e.g. for treating different degrees of hearing loss, a loudspeaker having an integrated output driver would not be well suited for this configuration. In cases where this type of flexibility is desired, long wires between the output stage terminals of the hearing aid circuit and the terminals of the loudspeaker of the hearing aid are unavoidable. An extra set of long wires for the signal from the loudspeaker to the feedback circuit would also be required by the prior art output driver, which would further increase capacitive interference noise.

### SUMMARY OF THE INVENTION

The invention, in a first aspect, provides a hearing aid comprising an input transducer, an analog-to-digital converter, a digital signal processor, a three-level output modulator connected to a three-level output driver, a first voltage source, a second voltage source, a common voltage node and an acoustic output transducer, wherein the output driver comprises an H-bridge output stage configured to control the connection of a first and a second terminal of the acoustic output transducer, the H-bridge being configured to connect the first voltage source to the first terminal of the acoustic output transducer and the common voltage node to the second terminal of the acoustic output transducer when the output modulator generates a first level, to connect the second voltage source to both the first and the second terminal of the acoustic output transducer when the output modulator generates a second level, and to connect the first voltage source to the second terminal of the acoustic output transducer and the common voltage node to the first terminal of the acoustic output transducer when the output modulator generates a third level.

It is a feature of the present invention to devise an output stage for a hearing aid having an output converter capable of providing the benefits of a three-stage output converter without having the capacitive noise and interference problems associated with output converters of the prior art, regardless of having long wires connecting the output stage to the loudspeaker of the hearing aid.

The invention, in a second aspect, provides a method of driving an output stage of a hearing aid, said method comprising providing a single-bit digital signal representing an audio signal to be reproduced by the hearing aid, providing a first voltage source for generating a first voltage, providing a second voltage source for generating a second voltage, providing an acoustic output transducer, converting the single-bit digital signal into a three-level control signal comprising a positive level, a negative level, and a zero level, connecting the first voltage source to a first terminal of the acoustic output transducer, and connecting a second terminal of the acoustic output transducer to ground, whenever the control signal produces a negative level, connecting the first voltage source to the second terminal of the acoustic output transducer, and connecting the first terminal of the acoustic output transducer to ground, whenever the control signal produces a positive level, and connecting the second voltage source to both the first terminal and the second terminal of the acoustic output transducer whenever the control signal produces a zero level.

### BRIEF DESCRIPTION OF THE DRAWINGS

The invention will now be described in further detail with respect to the drawings, where

FIG. 1 is a schematic of an output stage for a hearing aid according to the prior art,

FIG. 2 is a schematic of an output stage for a hearing aid according to an embodiment of the invention,

FIG. 3 is a schematic illustrating a first condition in the output stage of FIG. 2,

FIG. 4 is a schematic illustrating a second condition in the output stage of FIG. 2,

FIG. 5 is a schematic illustrating a third condition in the output stage of FIG. 2,

FIG. 6 is a graph illustrating a typical input signal to the output stage of FIG. 2, and

FIG. 7 is a schematic of a hearing aid with an output stage according to an embodiment of the invention.

### DETAILED DESCRIPTION

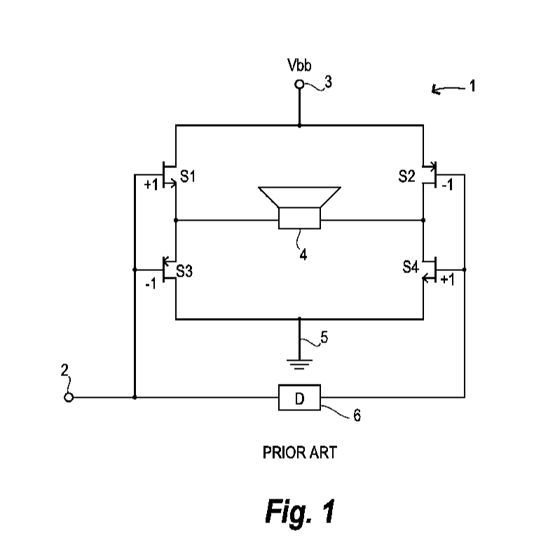

FIG. 1 shows a schematic of a three-state digital H-bridge output stage 1 of a hearing aid according to the prior art. The output stage 1 comprises a control input 2, a supply voltage node 3 carrying a positive voltage V_{bb}, an acoustic output transducer shown as a loudspeaker 4, a ground node 5, a delay element 6, and four controllable switches S1, S2, S3 and S4, shown as MOSFET transistor elements. The supply voltage node 3 provides electrical power to the H-bridge output stage 1, and the control input 2 is capable of delivering a bit stream for controlling the four controllable switches S1, S2, S3 and S4. The purpose of the delay element 6 is to perform a delay of the bit stream for the switches S2 and S4 by one clock pulse. This function may also be performed by an inverter. In the following, the three different conditions produced by the output stage from the bit stream are denoted “−1”, “0” and “+1”. The purpose of the switches S1, S2, S3 and S4 is to provide a current flow from the supply voltage node 3 and through the loudspeaker 4, controlled by the bit stream from the control input 2, to the ground terminal 5.

The switches are controlled in the following manner. Whenever the bit stream produces a bit sequence comprising a “0” followed by a “0”, the switches S2 and S3 close, and the switches S1 and S4 open, corresponding to the condition “−1” in the output stage. This condition causes a current to flow from the supply voltage node 3 through S2, the loudspeaker 4 and S3, respectively, to ground. The current flow causes the membrane or diaphragm of the loudspeaker 4 to move in one direction, e.g. inwards.

Whenever the bit stream produces a bit sequence comprising a “0” followed by a “1”, or a “1” followed by a “0”, the switches S1 and S2 close, and the switches S3 and S4 open, or vice versa, corresponding to the condition “0” in the output stage. This condition causes the voltage potential of the supply voltage node 3 to be present on both sides of the loudspeaker 4 due to S1 and S2 being closed. If S3 and S4 are closed instead, the ground potential will be present on both sides of the loudspeaker 4. Since the same voltage potential is present on both sides of the loudspeaker 4, the diaphragm of the loudspeaker 4 will now move towards its neutral position.

Whenever the bit stream produces a bit sequence of a “1” followed by a “1”, The switches S1 and S4 close, and the switches S2 and S3 open, corresponding to the condition “+1” in the output stage. This condition causes a current to flow from the supply voltage node 3 through S1, the loudspeaker 4 and S4, respectively, to ground. The current flow causes the diaphragm of the loudspeaker 4 to move in the opposite direction with respect to the condition “−1” in the output stage, e.g. outwards.

This design does provide a very power-efficient output stage when compared to earlier two-level output stage designs. However, it also has the inherent drawback of producing a considerable amount of capacitive interference due to its mode of operation. When the output stage is in the condition “+1” or “−1”, the switches are controlled in a synchronous manner by the bit stream, but when the output converter is in the condition “0”, this synchronicity is lost due to the switches not being controlled from the same logic circuit. The spikes resulting from this asynchronous switching are too high in frequency to affect the general operation of the acoustic output transducer but they do generate a considerable amount of capacitive interference, which may compromise wireless near field communication signals, e.g. from a wireless remote control adapted for communicating with receiver circuitry in the hearing aid, and thus reduce the effective operating range of the wireless remote control.

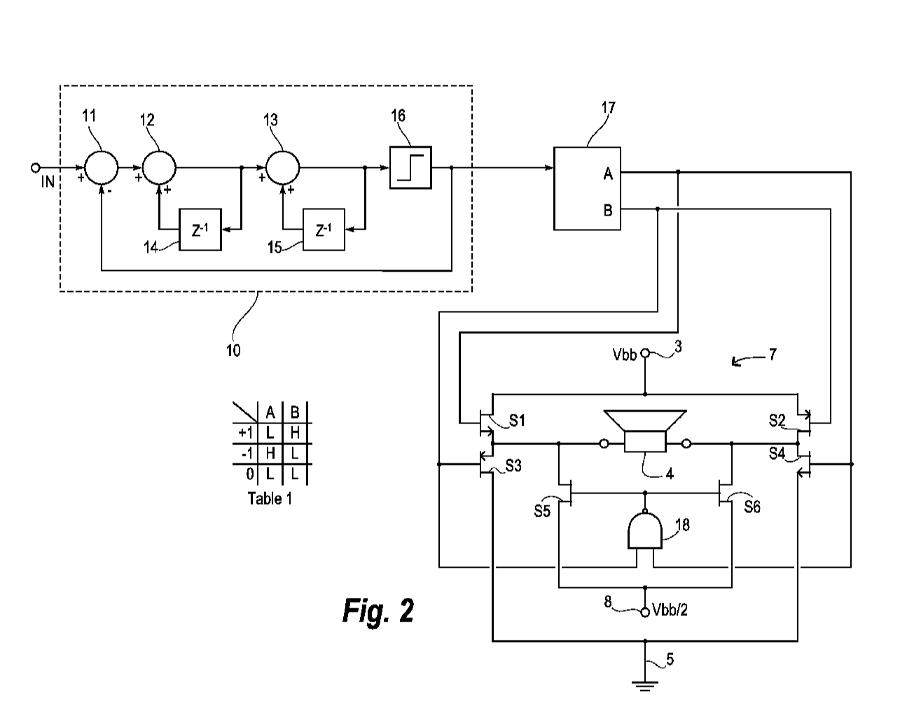

FIG. 2 is a schematic showing a sigma-delta modulator 10, a decoder network 17 and an H-bridge output stage 7 for a hearing aid according to the invention. The sigma-delta modulator 10 comprises a difference node 11, a first summation node 12, a second summation node 13, a first unit delay block 14, a second unit delay block 15, and a quantizer 16. The output stage 7 comprises a first supply voltage node 3, a ground node 5, a second supply voltage node 8, a NAND-gate 18, a loudspeaker 4, a first controllable switch S 1, a second controllable switch S2, a third controllable switch S3, a fourth controllable switch S4, a fifth controllable switch S5, and a sixth controllable switch S6. Also shown in FIG. 2 is a table illustrating the operation of the decoder network 17, denoted Table 1.

The input of the sigma-delta modulator 10 is connected to an output of a digital signal processor of a hearing aid (not shown), and the output of the sigma-delta modulator 10 is connected to an input of the decoder network 17. The decoder network 17 comprises a first output A and a second output B. The first output A is connected to the inputs of the first controllable switch S1 and the fourth controllable switch S4, and the second output B is connected to the third controllable switch S3 and the second controllable switch S2.

The first supply voltage node 3 and the second supply voltage node 8 provides electrical power to the H-bridge output stage 7, and four of the eight controllable switches, S1, S2, S3 and S4, are controlled by the decoder network 17 for controlling three different conditions of the output stage 7, denoted “−1”, “0” and “+1”, respectively. The NAND-gate 18 has a first input connected to the first output A of the decoder network 17, and a second input connected to the second output B of the decoder network 17. The operation of the decoder network 17 is illustrated in Table 1, where L denotes a LOW logical level, and H denotes a HIGH logical level.

The first supply voltage node 3 preferably carries the nominal supply voltage V_{bb} of the hearing aid in order to maximize the output of the loudspeaker 4, but other voltages may be used for driving the loudspeaker 4, e.g. a voltage delivered by a voltage-doubler being powered by the battery of the hearing aid. The second supply voltage node 8 preferably carries half the voltage of the first supply voltage node 3. The reasoning behind this preference will be explained in greater detail in the following.

The four controllable switches S1, S2, S3 and S4 operate in a fashion generally similar to the prior art output stage 1 shown in FIG. 1 regarding generation of the output conditions “−1” and “+1”, but the output stage 7 has a novel way of generating the output condition “0”. The NAND-gate 18 outputs a logical HIGH if, and only if, both the first output A and the second output B of the decoder network 17 are LOW. The two controllable switches S5 and S6 are controlled by the NAND-gate 18.

When activated by a logical HIGH level, the fifth controllable switch S5 connects the first loudspeaker terminal to the second supply node 8, and the sixth controllable switch S6 connects the second loudspeaker terminal to the second supply node 8. When deactivated by a logical LOW level, the fifth controllable switch S5 and the sixth controllable switch S6, respectively, disconnects both the loudspeaker terminals from the second supply node 8. In other words, whenever the NAND-gate 18 outputs a logical HIGH, the first and the second loudspeaker terminal are both connected to the second supply node 8.

If the voltage potential on the second supply voltage node 8 were configured to equal either the voltage potential on the first supply voltage node 3 or the ground potential, the output stage 7 would operate in essentially the same way as the output stage of the prior art, including the problems with capacitive interference discussed earlier. However, if the voltage potential on the second supply voltage node 8 is set to be equal to V_{bb}/2, or half the voltage of the first supply voltage node 3, the capacitive interference from the output stage 7 is balanced out to the same degree as if the output stage 7 was a two-level output stage.

In this configuration, the acoustic output transducer has an effective voltage swing about the potential V_{bb}/2 of the second voltage supply node 8 of the difference between the ground potential and the voltage potential V_{bb} of the first supply voltage node 3, but the voltage shifts on either wire connecting the output stage 7 of the hearing aid circuit to the loudspeaker 4 equals only half the potential V_{bb} of the first supply voltage node 3 due to the three-level operation of the output converter. Since the shifts to generate a “0” are now performed in a synchronous manner by the NAND-gate 18, by closing the switches S5 and S6 whenever both the first output A and the second output B of the decoder network 17 are LOW, the capacitive noise interference level is reduced by at least 6 dB. Apart from the current-saving benefits, a three-level output stage operation inherently has the benefits of a lower switching noise level over time, since shifts due to a typical signal are less frequent compared to a two-level switching output stage.

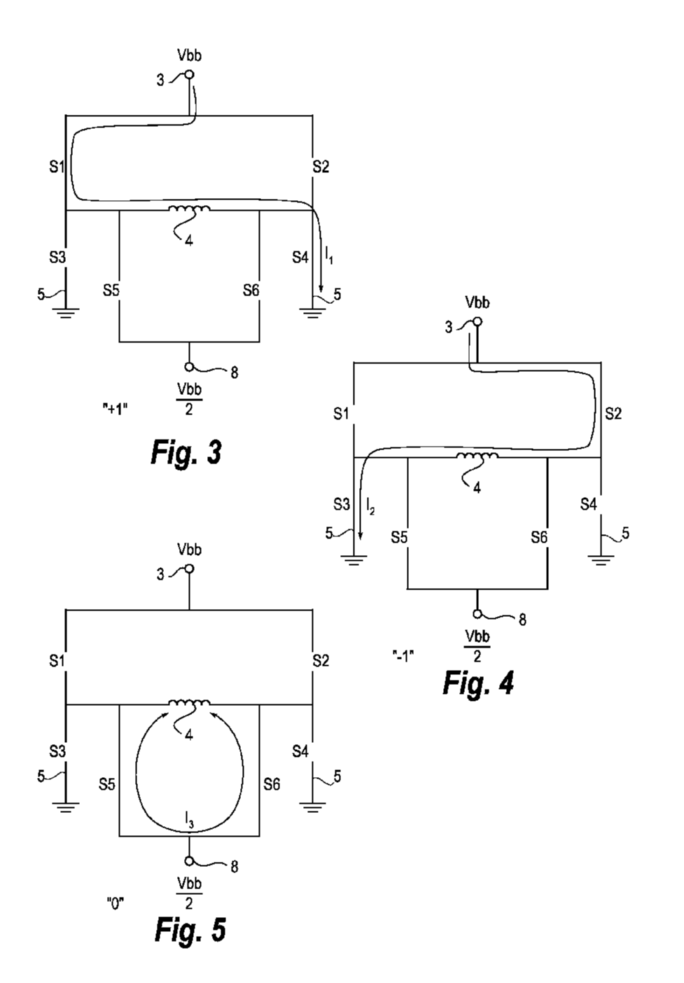

The operation of the output stage 7 according to the invention is explained in greater detail with respect to FIGS. 3, 4 and 5, which are simplified schematic diagrams of the output stage 7 shown in FIG. 2, illustrating how the output stage 7 handles the conditions “−1”, “0” and “+1”. The first voltage supply node 3 and the second voltage supply node 8 are shown in FIG. 3, FIG. 4 and FIG. 5. The six switches S1, S2, S3, S4, S5 and S6 are only suggested in FIG. 3, FIG. 4 and FIG. 5, and the loudspeaker is suggested in FIG. 3, FIG. 4 and FIG. 5 as a coil 4.

In FIG. 3 it is illustrated how the output stage 7 generates the condition “+1”. The switches S1 and S4 are closed, while the switches S2, S3, S5 and S6 are open. Due to the voltage difference between the first supply voltage node 3 and ground, an electrical current I₁ flows from the first supply voltage node 3 through S1, through the loudspeaker 4 and through S4 to ground, exerting an electromotive force on the loudspeaker coil, thus forcing the membrane of the loudspeaker 4 to move in one direction, e.g. inwards.

In FIG. 4 is illustrated how the output stage 7 generates the condition “−1”. The switches S2 and S3 are now closed, while the switches S1, S4, S5 and S6 are open. An electrical current I₂ flows from the first supply voltage node 3 through S2, through the loudspeaker 4 in the opposite direction, and through S3 to ground, exerting an electromotive force on the loudspeaker coil, thus forcing the membrane of the loudspeaker 4 move in the opposite direction, e.g. outwards.

In FIG. 5 is illustrated how the output stage 7 generates the condition “0”. The switches S5 and S6 are now closed, while the switches S1, S2, S3 and S4 are open. The voltage potential of the second supply voltage node 8 is now applied on both terminals of the loudspeaker 4 simultaneously. Unless the membrane of the loudspeaker 4 is at its resting position, it is now forced to move towards this resting position. This movement causes an electrical current I₃ to flow in the closed circuit formed by the switch S5, the loudspeaker 4 and the switch S6. As the same voltage potential is applied to both terminals of the loudspeaker 4 by the second supply voltage node 8, the current I₃ originates solely from the electromotive force induced in the loudspeaker coil by the resilient force provided by the loudspeaker suspension. When the loudspeaker is in its resting position, and not in motion, the current I₃ is zero. By generating the condition “0” in the three-level output converter of the invention in this way, capacitive interference is reduced.

The voltage potential provided by the second supply voltage node 8 may, in a preferred embodiment, be generated by dividing the voltage potential of the first supply voltage node 3 by two, e.g. by providing a simple voltage divider having a sufficiently high output impedance and eventually being decoupled by a small capacitor. In another preferred embodiment, a switched-capacitor voltage divider is provided for generating the voltage potential for the second supply voltage node 8 from the voltage potential of the first supply voltage node 3. A switched-capacitor voltage divider is a preferred choice in clocked, integrated circuit designs, and has the added advantage of having inherently high input impedance.

As stated in the foregoing, a three-level digital output stage has the advantage of performing fewer shifts for reproduction of the same signal when compared with a two-level digital output stage. This implies lower power consumption. In a preferred embodiment, the circuit providing the control signals for the digital output stage utilizes a combination of pulse-width modulation and sigma-delta modulation. A sufficient driver frequency bandwidth may thus be obtained, even if the typical clock frequency of 1 MHz for the output stage is reduced to 256 kHz.

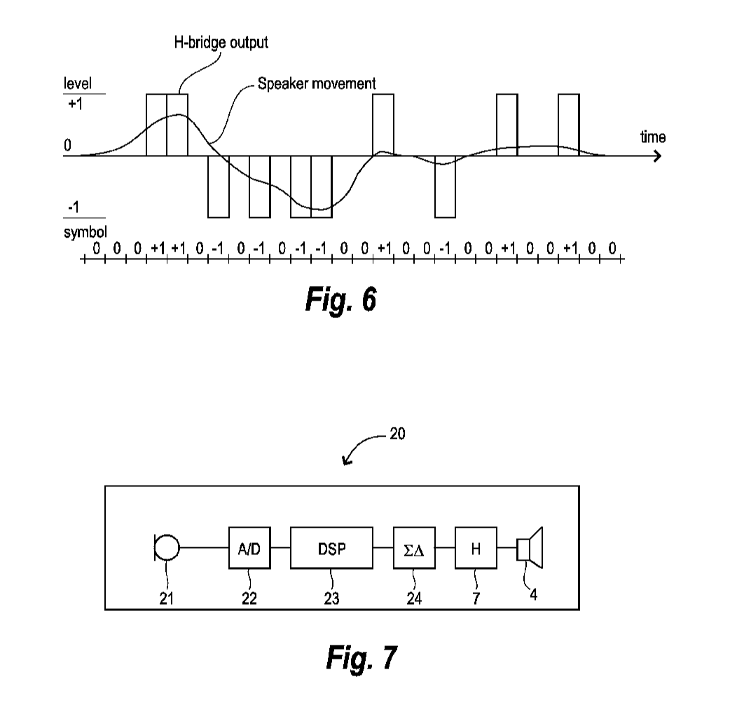

FIG. 6 shows a time-domain graph of a typical output signal from the H-bridge output converter according to the invention. The H-bridge output signal is a series of equidistant, clocked signal pulses representing the audio signal to be reproduced. This signal may take one of three distinct values, “−1”, “0” or “+1”. Also shown in the graph in FIG. 6 is the resulting loudspeaker movement. “+1” corresponds to the innermost extreme position attainable by the loudspeaker membrane, “−1” corresponds to the outermost extreme position, and “0” corresponds to the loudspeaker resting position. Due to the low-pass filtering effect of the loudspeaker coil on the input signal, the curve representing the speaker movement is approximating a smoothed integral of the values presented by the H-bridge output signal. Below the graph in FIG. 6 is also shown a series of symbols representing the bit stream generating the output signal from the H-bridge.

FIG. 7 is a schematic of a hearing aid 20 having a digital output stage 7 according to the invention. The hearing aid 20 comprises a microphone 21, an A/D converter 22, a digital signal processor 23, a sigma-delta converter 24, the output stage 7 and the loudspeaker 4.

Acoustic signals are picked up by the microphone 21 and converted into an analog electrical signal. The analog electrical signal from the microphone 21 is converted into a digital signal by the A/D converter 22. The A/D converter 22 provides the digital signal to the input of the digital signal processor 23, where the majority of the processing of the digitized microphone signal takes place in the hearing aid 20. From the output of the digital signal processor 23, the processed digital output signal is used as an input signal for the sigma-delta converter 24.

The sigma-delta converter 24 uses the processed, digital output signal from the digital signal processor 23 as an input signal for generating a three-level bit stream suitable as a digital input signal for the H-bridge output stage 7. The H-bridge output stage 7 is configured to drive the loudspeaker 4 directly, controlled by the three-level bit stream. The hearing aid output stage according to the invention has significantly reduced capacitive interference without tradeoffs in the form of increased power consumption or added complexity.

We claim:

1. A hearing aid comprising an input transducer, an analog-to-digital converter, a digital signal processor, a three-level output modulator connected to a three-level output driver, a first voltage source, a second voltage source, a common voltage node and an acoustic output transducer, wherein the output driver comprises an H-bridge output stage configured to control the connection of a first and a second terminal of the acoustic output transducer, the H-bridge being configured to connect the first voltage source to the first terminal of the acoustic output transducer and the common voltage node to the second terminal of the acoustic output transducer when the output modulator generates a first level, to connect the second voltage source to both the first and the second terminal of the acoustic output transducer when the output modulator generates a second level, and to connect the first voltage source to the second terminal of the acoustic output transducer and the common voltage node to the first terminal of the acoustic output transducer when the output modulator generates a third level.

2. The hearing aid according to claim 1, wherein the second voltage source is configured to provide a voltage level of substantially half the voltage level of the first voltage source.

3. The hearing aid according to claim 1, wherein the output modulator is a sigma-delta modulator.

4. The hearing aid according to claim 1, wherein the output modulator is a pulse-width modulator.

5. The hearing aid according to claim 1, wherein the output modulator is a combined pulse-width modulator and sigma-delta modulator.

6. A method of driving an output stage of a hearing aid, said method comprising
providing a single-bit digital signal representing an audio signal to be reproduced by the hearing aid,
providing a first voltage source for generating a first voltage,
providing a second voltage source for generating a second voltage,
providing an acoustic output transducer,
converting the single-bit digital signal into a three-level control signal comprising a positive level, a negative level, and a zero level,
connecting the first voltage source to a first terminal of the acoustic output transducer, and connecting a second terminal of the acoustic output transducer to ground, whenever the control signal produces a negative level,
connecting the first voltage source to the second terminal of the acoustic output transducer, and connecting the first terminal of the acoustic output transducer to ground, whenever the control signal produces a positive level, and
connecting the second voltage source to both the first terminal and the second terminal of the acoustic output transducer whenever the control signal produces a zero level.

7. The method according to claim 6, wherein the voltage level of the second voltage source is substantially half the voltage of the first voltage source.

8. The method according to claim 6, wherein the connections controlled by the control signal are provided by semiconductor elements.

9. The method according to claim 6, wherein the voltage of the second voltage is derived from the first voltage.
